(19) United States
(12) Patent Application Publication
(10) Pub. No.: US 2026/0370798 A1
(43) Pub. Date: Nov. 19, 2026

(54) SYSTEMS AND METHODS FOR ADAPTIVELY MODIFYING DISPLAY PROPERTIES IN A THREE-DIMENSIONAL DISPLAY

(71) Applicant: Dell Products L.P., Round Rock, TX (US)

(72) Inventors: Wei-Hsiang CHI, Taipei (TW); Shohrab SHEIKH, Singapore (SG); Jace W. FILES, Round Rock, TX (US)

(73) Assignee: Dell Products L.P., Round Rock, TX (US)

(21) Appl. No.: 19/209,103

(22) Filed: May 15, 2025

(51) Int. Cl. H04N 13/398; G06F 1/3234; H04N 13/366

(52) U.S. Cl. CPC H04N 13/398; G06F 1/3265; H04N 13/366

(57) ABSTRACT

An information handling system includes a processor and a non-transitory computer-readable medium embodying a program of instructions. A camera tracks eye movements of a user and provides one or more signals indicative of an amount of motion of the user's eyes. The processor determines whether the amount of motion exceeds a threshold. When the amount of motion exceeds the threshold, the camera, an associated autostereoscopic three-dimensional display, or both enter a low latency mode. When the amount of motion does not exceed the threshold, the camera, the display, or both enter a power savings mode. The modes balance power consumption against motion-to-photon latency in the three-dimensional display.

### TECHNICAL FIELD

The present disclosure relates in general to information handling systems, and more particularly, to adaptively modifying display properties in a three-dimensional display.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have long used display devices, whether externally coupled to the information handling system or integrated within the information handling system, in order to display information to users, including alphanumerical data and graphical images. Increasingly, display devices are equipped with three-dimensional capabilities, giving a user a perception of depth from a display device.

Autostereoscopic three-dimensional display is a technology that is increasingly used to create an illusion of depth to a user with a two-dimensional monitor without the use of three-dimensional glasses. In such technology, a lenticular lens array film may be added to the display device to simulate the effect of a parallax barrier. In essence, two different pixel areas generate two different images observed by a user's left eye and right eye in order to allow the user to visually perceive a three-dimensional image. Complex algorithms may receive two-dimensional images and a depth map as inputs and process such inputs to render distinct images for each eye of the user to give an illusion of three-dimensional imagery.

Autostereoscopic three-dimensional display devices may also include a stereo camera to track user eye movements, to aid in accurately displaying images to a user. Latency in tracking such eye movements may be critical to user experience. For example, in some applications, ideal latency from motion of user to generation of photon in response is within 20 ms. To achieve such latency in a three-dimensional display, a tracking camera may need to operate at 150 frames per second or more and/or a display device may need to operate at 120 frames per second or more, which may consume significant levels of power. Accordingly, methods and systems for balancing power consumption and latency may be desirable.

### SUMMARY

In accordance with the teachings of the present disclosure, one or more disadvantages and problems associated with existing approaches to three-dimensional display may be reduced or eliminated.

In accordance with embodiments of the present disclosure, an information handling system may include a processor and a non-transitory computer-readable medium embodying a program of instructions, the program of instructions configured to, when read and executed by the processor: receive one or more signals from a camera indicative of an amount of motion of a user of the information handling system, determine whether the amount of motion exceeds a threshold, cause at least one of the camera and a display associated with the information handling system to enter a low latency mode if the amount of motion exceeds the threshold, and cause at least one of the camera and the display to enter a power savings mode if the threshold exceeds the amount of motion.

In accordance with these and other embodiments of the present disclosure, a method may include receiving one or more signals from a camera indicative of an amount of motion of a user of an information handling system, determining whether the amount of motion exceeds a threshold, causing at least one of the camera and a display associated with the information handling system to enter a low latency mode if the amount of motion exceeds the threshold, and causing at least one of the camera and the display to enter a power savings mode if the threshold exceeds the amount of motion.

In accordance with these and other embodiments of the present disclosure, an article of manufacture may include a non-transitory computer readable medium and computer-executable instructions carried on the non-transitory computer readable medium, the instructions readable by a processor, the instructions, when read and executed, for causing the processor to: receive one or more signals from a camera indicative of an amount of motion of a user of an information handling system, determine whether the amount of motion exceeds a threshold, cause at least one of the camera and a display associated with the information handling system to enter a low latency mode if the amount of motion exceeds the threshold, and cause at least one of the camera and the display to enter a power savings mode if the threshold exceeds the amount of motion.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example image capture system, in accordance with embodiments of the present disclosure; and

FIG. 2 illustrates a flow chart of an example method for adaptively modifying display properties in a three-dimensional display, in accordance with embodiments of the present disclosure.

### DETAILED DESCRIPTION

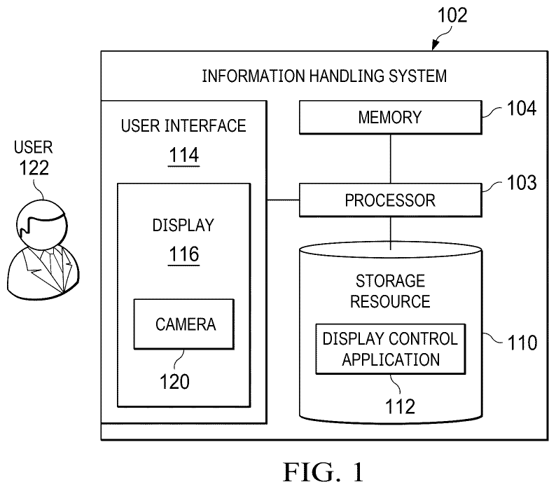

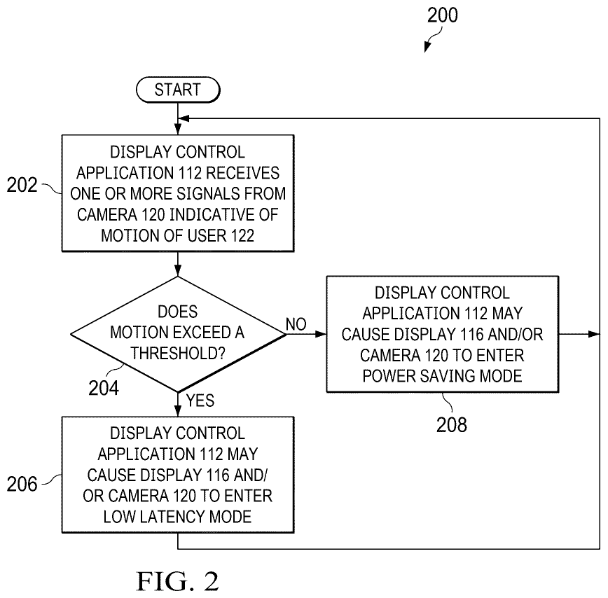

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e. g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example image capture system comprising an information handling system 102, in accordance with embodiments of the present disclosure. In certain embodiments, information handling system 102 may comprise a personal computer (e.g., a desktop computer or a portable computer). In these and other embodiments, information handling system 102 may comprise a mobile device (e.g., smart phone, a tablet computing device, a handheld computing device, a personal digital assistant, or any other device that may be readily transported on a person of a user of such mobile device).

As depicted in FIG. 1, information handling system 102 may include a processor 103, a memory 104 communicatively coupled to processor 103, a storage resource 110 communicatively coupled to processor 103, and a user interface 114 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in its memory 104, storage resource 110, and/or another component of information handling system 102.

Memory 104 may be communicatively coupled to its associated processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

Each storage resource 110 may include a system, device, or apparatus configured to store data. A storage resource 110 may include one or more hard disk drives, magnetic tape libraries, optical disk drives, magneto-optical disk drives, solid state storage drives, compact disk drives, compact disk arrays, disk array controllers, and/or any other systems, apparatuses or devices configured to store data. In certain embodiments, storage resource 110 may include one or more storage enclosures configured to hold and/or power one or more of such devices. In the embodiments represented by FIG. 1, storage resource 110 may reside within its associated information handling system 102. However, in other embodiments, storage resource 110 may reside external to its associated information handling system 102 (e.g., may be coupled to information handling system 102 via a network).

As shown in FIG. 1, a storage resource 110 may have stored thereon a display control application 112. Display control application 112 may comprise a program of instructions which a processor 103 may read and execute to adaptively modify properties of display 116 of user interface 114, as described in greater detail below. When executed, active portions of display control application 112 may be loaded from storage resource 110 into memory 104 for execution by processor 103. Display control application 112 may comprise an application program configured to execute of an operating system of information handling system 102, or may comprise a driver or utility of such an operating system.

User interface 114 may comprise any instrumentality or aggregation of instrumentalities by which a participant subject 122 may interact with information handling system 102. For example, user interface 114 may permit a user to input data and/or instructions into information handling system 102 (e.g., via a keypad, keyboard, touch screen, microphone, camera, and/or other data input device), and/or otherwise manipulate information handling system 102 and its associated components. User interface 114 may also permit information handling system 102 to communicate data to a participant 122 (e.g., via a display device, speaker, and/or other data output device). As shown in FIG. 1, user interface 114 may include a display 116. For purposes of clarity and exposition, FIG. 1 depicts display 116 (and its integrated camera 120) as the only components of user interface 114. However, user interface 114 may include other components, including one or more of a microphone, a speaker, a keyboard, and/or a pointing device (e.g., a mouse, trackball, or trackpad).

A display 116 may comprise any suitable system, device, or apparatus configured to display human-perceptible graphical data and/or alphanumeric data to a user 122. For example, in some embodiments, display 116 may comprise a liquid crystal display. In some embodiments, display 116 may be integral to a housing of information handling system 102 (e.g., as shown in FIG. 1), as may be the case in a laptop, notebook, or smart phone. In other embodiments, display 116 may be external to information handling system 102 and coupled to information handling system 102 via an appropriate external port. Display 116 may comprise an autostereoscopic three-dimensional display.

As shown in FIG. 1, display 116 may include a camera 120 integrated therein, although in some embodiments, camera 120 may be separate from display 116. Camera 120 may comprise any system, device, or apparatus configured to record images (moving or still) into one or more electrical signals that may be processed by processor 103, including being processed by display control application 112 executing on processor 103. In some embodiments, camera 120 may comprise a stereo camera including two or more lenses with a separate image sensor or film frame for each lens, thus allowing camera 120 to simulate human binocular vision. In particular, in connection with three-dimensional display 116, camera 120 may be used for range imaging, in order to track eye movements of user 122, to aid display 116 in accurately displaying three-dimensional images to user 122.

In addition to processor 103, memory 104, storage resource 110, and user interface 114, information handling system 102 may include one or more other information handling resources. Such an information handling resource may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

FIG. 2 illustrates a flow chart of an example method 200 for adaptively modifying display properties in a three-dimensional display, in accordance with embodiments of the present disclosure. As noted above, teachings of the present disclosure may be implemented in a variety of configurations of information handling system 102. As such, the preferred initialization point for method 200 and the order of the steps comprising method 200 may depend on the implementation chosen.

At step 202, display control application 112 may receive one or more signals from camera 120 indicative of motion of user 122, such as motion of the eyes of user 122, for example. At step 204, display control application 112 may determine if motion associated with user 122 exceeds a threshold. In some embodiments, display control application 112 may user machine-learning trained data to make such determination. In these and other embodiments, such threshold may be based on user experience testing on different configurations and scenarios of use associated with information handling system 102, including different sizes of display 116, form factor of information handling system (e. g., a display integrated within a notebook versus an externally-attached monitor), and/or uses of information handling system 102 (e.g., gaming, productivity, computer-aided design, etc.). If the motion associated with user 122 exceeds the threshold, method 200 may proceed to step 206. Otherwise, method 200 may proceed to step 208.

At step 206, in response to the motion associated with user 122 exceeding the threshold, display control application 112 may cause display 116 and/or camera 120 to enter a low latency mode. In such low latency mode, display control application 112 may set a frame-per-second rate of display 116 to a first display frame rate and/or set a frame-per-second rate of camera 120 to a first camera frame rate. In additional or alternatively, in such low latency mode, display control application 112 may cause execution of a display algorithm optimized for the low latency mode. After completion of step 206, method 200 may proceed again to step 202.

At step 208, in response to the motion associated with user 122 not exceeding the threshold, display control application 112 may cause display 116 and/or camera 120 to enter a power saving mode. In such power saving mode, display control application 112 may set a frame-per-second rate of display 116 to a second display frame rate substantially smaller than the first display frame rate and/or set a frame-per-second rate of camera 120 to a second camera frame rate substantially smaller than the first camera frame rate. In additional or alternatively, in such power saving mode, display control application 112 may cause execution of a display algorithm optimized for the power saving mode. After completion of step 208, method 200 may proceed again to step 202.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using one or more information handling systems 102, components thereof, and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1. An information handling system, comprising:
a processor; and
a non-transitory computer-readable medium embodying a program of instructions, the program of instructions configured to, when read and executed by the processor:
receive one or more signals from a camera that tracks eye movements of a user of the information handling system, the one or more signals being indicative of an amount of motion of the eyes of the user;
determine whether the amount of motion exceeds a threshold;
cause at least one of the camera and a display associated with the information handling system, the display comprising an autostereoscopic three-dimensional display, to enter a low latency mode if the amount of motion exceeds the threshold; and
cause at least one of the camera and the display to enter a power savings mode if the amount of motion does not exceed the threshold;
wherein the threshold is based on a size of the display.

2. The information handling system of claim 1, the program of instructions further configured to:
in the low latency mode, set a frame-per-second rate of the display to a first display frame rate; and
in the power savings mode, set the frame-per-second rate of the display to a second display frame rate lower than the first display frame rate.

3. The information handling system of claim 1, the program of instructions further configured to:
in the low latency mode, set a frame-per-second rate of the camera to a first camera frame rate; and
in the power savings mode, set the frame-per-second rate of the camera to a second camera frame rate lower than the first camera frame rate.

4. The information handling system of claim 1, the program of instructions further configured to:
in the low latency mode, cause execution of a display algorithm that reduces latency of the display in the low latency mode; and
in the power savings mode, cause execution of a display algorithm that reduces power consumption of the display in the power savings mode.

5. The information handling system of claim 1, wherein the threshold is based on user experience testing on one or more of different sizes of the display and different form factors of the information handling system.

6. (canceled)

7. The information handling system of claim 1, wherein the camera comprises a stereo camera.

8. A method comprising:
receiving one or more signals from a camera that tracks eye movements of a user of an information handling system, the one or more signals being indicative of an amount of motion of the eyes of the user;
determining whether the amount of motion exceeds a threshold;
causing at least one of the camera and a display associated with the information handling system, the display comprising an autostereoscopic three-dimensional display, to enter a low latency mode if the amount of motion exceeds the threshold; and
causing at least one of the camera and the display to enter a power savings mode if the amount of motion does not exceed the threshold;
wherein the threshold is based on a size of the display.

9. The method of claim 8, further comprising:
in the low latency mode, setting a frame-per-second rate of the display to a first display frame rate; and
in the power savings mode, setting the frame-per-second rate of the display to a second display frame rate lower than the first display frame rate.

10. The method of claim 8, further comprising:
in the low latency mode, setting a frame-per-second rate of the camera to a first camera frame rate; and
in the power savings mode, setting the frame-per-second rate of the camera to a second camera frame rate lower than the first camera frame rate.

11. The method of claim 8, further comprising:
in the low latency mode, causing execution of a display algorithm that reduces latency of the display in the low latency mode; and
in the power savings mode, causing execution of a display algorithm that reduces power consumption of the display in the power savings mode.

12. The method of claim 8, wherein the threshold is based on user experience testing on one or more of different sizes of the display and different form factors of the information handling system.

13. (canceled)

14. The method of claim 8, wherein the camera comprises a stereo camera.

15. An article of manufacture comprising:
a non-transitory computer readable medium; and
computer-executable instructions carried on the non-transitory computer readable medium, the instructions readable by a processor, the instructions, when read and executed, for causing the processor to:
receive one or more signals from a camera that tracks eye movements of a user of an information handling system, the one or more signals being indicative of an amount of motion of the eyes of the user;
determine whether the amount of motion exceeds a threshold;
cause at least one of the camera and a display associated with the information handling system, the display comprising an autostereoscopic three-dimensional display, to enter a low latency mode if the amount of motion exceeds the threshold; and
cause at least one of the camera and the display to enter a power savings mode if the amount of motion does not exceed the threshold;
wherein the threshold is based on a size of the display.

16. The article of claim 15, further comprising:
in the low latency mode, setting a frame-per-second rate of the display to a first display frame rate; and
in the power savings mode, setting the frame-per-second rate of the display to a second display frame rate lower than the first display frame rate.

17. The article of claim 15, further comprising:
in the low latency mode, setting a frame-per-second rate of the camera to a first camera frame rate; and
in the power savings mode, setting the frame-per-second rate of the camera to a second camera frame rate lower than the first camera frame rate.

18. The article of claim 15, further comprising:
in the low latency mode, causing execution of a display algorithm that reduces latency of the display in the low latency mode; and
in the power savings mode, causing execution of a display algorithm that reduces power consumption of the display in the power savings mode.

19. The article of claim 15, wherein the threshold is based on user experience testing on one or more of different sizes of the display and different form factors of the information handling system.

20. (canceled)

21. The article of claim 15, wherein the camera comprises a stereo camera.
